(19) United States
(12) Patent Application Publication
(10) Pub. No.: US 2013/0317723 A1
(43) Pub. Date: Nov. 28, 2013

(54) METHOD FOR DETERMINING A TYPE OF AIR-FUEL MIXTURE ERROR

(71) Applicant: Daimler AG, Stuttgart (DE)

(72) Inventors: Patrick Deubler, Sindelfingen (DE); Kay Dietzel, Wendlingen (DE); Thomas Kaiser, Denkendorf (DE); Peter Hohner, Stuttgart (DE)

(73) Assignee: Daimler AG, Stuttgart (DE)

(21) Appl. No.: 13/887,340

(22) Filed: May 5, 2013

(30) Foreign Application Priority Data
Nov. 11, 2010 (DE) 10 2010 051 034.3

(51) Int. Cl. F02D 41/14

(52) U.S. Cl. CPC F02D 41/1495
USPC 701/104

(57) ABSTRACT

In a method for determining a type of air-fuel mixture error of a cylinder of an internal combustion engine of a motor vehicle, wherein
a torque parameter (M1) of the cylinder is ascertained,
a lambda parameter (λ1) of the cylinder is ascertained,
a torque reference parameter and a lambda reference parameter are ascertained, as a function of a comparison of the torque parameter (M1) with the torque reference parameter and as a function of a comparison of the lambda parameter (λ1) with the lambda reference parameter, the type of air-fuel mixture error is indicated to be a fuel path error or to be an air path error.

This is a Continuation-in-Part application of pending international patent application PCT/EP2011/005577 filed Nov. 5, 2011 and claiming the priority of German patent application 10 2010 051 034.3 filed Nov. 11, 2010.

### BACKGROUND OF THE INVENTION

The invention relates to a method for determining the type of air-fuel mixture error of a cylinder of an internal combustion engine of a motor vehicle and for correcting the air-fuel mixture error.

DE 19828279 A1 describes a method for equalizing cylinder-specific torque contributions in an internal combustion engine having a plurality of cylinders. In this method, a divergence of a torque contribution of one cylinder of an internal combustion engine from the torque contributions of other cylinders of the internal combustion engine is recognized and then, through an adjustment of an injection time of the cylinder, the torque contributions of all of the cylinders are aligned.

DE 102007043734 A1 describes a method for equalizing cylinder-specific lambda values of an internal combustion engine. In this method, based on a specific total lambda value of the internal combustion engine, the total lambda value is shifted to be stronger. A torque contribution for each cylinder of the internal combustion engine is measured as a function of the extent of a shift in the total lambda value. From the courses of the torque contributions of the cylinders as a function of the total lambda value, it can be concluded which cylinder is being operated too strongly or too weakly in comparison with the other cylinders. By adjusting an injection time of a comparatively strongly or weakly running cylinder, the lambda values of all of the cylinders are equalized whereby the quality of the exhaust gas of the internal combustion engine is improved.

DE 102004044808 A1 describes a method for recognizing cylinder-specific air and fuel errors of an internal combustion engine, regulatory interventions and measurements being carried out both in homogeneous operation and in shift operation of the internal combustion engine.

The three methods make it possible to recognize divergences of an air-fuel ratio from an ideal value in a cylinder-specific manner. However, whether a divergence of the air-fuel ratio of a specific cylinder is caused by a defect in an air path of the cylinder or by a defect in a fuel path of the cylinder either cannot be established at all or can only be established with considerable effort.

It is therefore the object of the present invention to determine accurately the cause of a divergence of an air-fuel ratio of a cylinder of an internal combustion engine in a simple and inexpensive way so that, firstly, any repair required as a result of the divergence can be carried out efficiently and, secondly, any correction to improve the running smoothness and the exhaust gas quality of the internal combustion engine can be optimized.

### SUMMARY OF THE INVENTION

In a method for determining a type of air-fuel mixture error of a cylinder of an internal combustion engine of a motor vehicle, wherein
a torque parameter (M1) of the cylinder is ascertained,
a lambda parameter (λ1) of the cylinder is ascertained,
a torque reference parameter and a lambda reference parameter are ascertained, as a function of a comparison of the torque parameter (M1) with the torque reference parameter and as a function of a comparison of the lambda parameter (λ1) with the lambda reference parameter, the type of air-fuel mixture error is indicated to be a fuel path error or to be an air path error.

According to the invention, the method determines the type of air-fuel mixture error of a cylinder of an internal combustion engine of a motor vehicle. In this method, both a torque parameter of the cylinder and a lambda parameter of the cylinder are ascertained. The torque parameter means here a torque contribution of the cylinder or a parameter proportional to the torque contribution of the cylinder, such as a segment time relating to the cylinder at a crankshaft of the internal combustion engine. The lambda parameter means here a lambda value of the cylinder which, for example, can be ascertained from a cylinder-specific measurement of an oxygen content by means of a broadband lambda probe or can be estimated by means of a method described in DE 102007043734 A1 specified above.

The torque parameter and the lambda parameter are ascertained under defined operating conditions of the internal combustion engine.

A torque reference parameter is also ascertained. The torque reference parameter indicates here for example a torque contribution of the cylinder in a new state, or in a non-defective state, under defined operating conditions of the internal combustion engine. The torque reference parameter can alternatively, for example, also mean an average torque contribution of all of the cylinders of the internal combustion engine or an average torque contribution of a selection of cylinders of the internal combustion engine.

A lambda reference parameter is also ascertained. The lambda reference parameter means here, for example, a lambda value of the cylinder in a new state, or in a non-defective state, under defined operating conditions of the internal combustion engine. The lambda reference parameter can alternatively, for example, also mean an average lambda value of all of the cylinders of the internal combustion engine or an average lambda value of a selection of cylinders of the internal combustion engine.

According to the invention, the ascertained torque parameter of the cylinder is compared with the torque reference parameter and the ascertained lambda parameter is compared with the lambda reference parameter.

The torque reference parameter and the lambda reference parameter are each parameters that at least approximately characterize a non-defective state of a cylinder. If it is known whether the lambda parameter of a cylinder, under defined operating conditions, based on a non-defective state of the internal combustion engine, has shifted to become stronger or weaker, and if it is simultaneously known whether the torque parameter of a cylinder, under defined operating conditions, based on the non-defective state of the internal combustion engine, has shifted in the direction of a higher torque contribution or of a lower torque contribution, then, within certain limits, it is possible to distinguish between an air path error and a fuel path error of the cylinder and in each case store a corresponding error entry in a memory of a control unit assigned to the internal combustion engine.

In a first development of the method, the torque parameter of the cylinder is derived from a measurement of a running smoothness of the cylinder. It is particularly easy and therefore advantageous here to derive the torque parameter of the cylinder from a measurement of a segment time at a crankshaft of the internal combustion engine.

The torque reference parameter of the cylinder and the lambda reference parameter of the cylinder are derived in a particularly easy manner respectively from an average value of all of the cylinders of the internal combustion engine or from a selection of the cylinders of the internal combustion engine. A reasonable selection of cylinders of the internal combustion engine is one consisting of cylinders having similar values to the average value.

A particularly advantageous development of the method according to the invention provides that:
in the case of a lambda parameter of the cylinder which is shifted to be stronger in comparison with the lambda reference parameter of the cylinder, and at the same time a torque parameter of the cylinder which is shifted in the direction of a lower torque contribution in comparison with the torque reference parameter of the cylinder, an air error, in particular an air deficiency error, is indicated,
in the case of a lambda parameter of the cylinder which is shifted to be weaker in comparison with the lambda reference parameter of the cylinder, and at the same time a torque parameter of the cylinder which is shifted in the direction of a higher torque contribution in comparison with the torque reference parameter of the cylinder, an air error, in particular an air excess error, is indicated,
in the case of a lambda parameter of the cylinder which is shifted to be weaker in comparison with the lambda reference parameter of the cylinder, and at the same time a torque parameter of the cylinder which is shifted in the direction of a lower or equal torque contribution in comparison with the torque reference parameter of the cylinder, a fuel error, in particular a fuel deficiency error, is indicated, and
in the case of a lambda parameter of the cylinder, which is shifted to be stronger in comparison with the lambda reference parameter of the cylinder, and at the same time a torque parameter of the cylinder, which is shifted in the direction of a higher or equal torque contribution in comparison with the torque reference parameter of the cylinder, a fuel error, in particular a fuel excess error, is indicated.

The terms “simultaneously” and “at the same time” used above mean here that the information in question has been ascertained in the same measurement cycle. A measurement cycle may extend here over one or more driving cycles depending on whether the sequence of operating conditions needed for measurement has taken place in one or more driving cycles. A driving cycle means here a vehicle operation between switching the internal combustion engine on and switching the internal combustion engine off.

Said parameters and reference parameters can be ascertained under variable operating conditions, comparisons only being carried out between those parameters and reference parameters that were ascertained under the same operating conditions of the internal combustion engine.

Advantageously, the method is based on limit values that are ascertained system-specifically, it being possible for the limit values for different operating conditions to be stored in the form of characteristic maps in the memory of the control unit. For example, a strength divergence of the lambda parameter of the cylinder is only ascertained if a strength limit value for the lambda parameter of the cylinder is exceeded under associated operating conditions. The same principle advantageously also applies in the case of a weakness divergence of the lambda parameter and of divergences of the torque parameter.

In an alternative development of the method provides as follows:
a first injection quantity correction is ascertained as a function of a comparison of the torque parameter with the torque reference parameter according to a torque equalization method and
a second injection quantity correction is ascertained as a function of a comparison of the lambda parameter with the lambda reference parameter according to a lambda equalization method and
the type of the air-fuel mixture error is set to equal a fuel path error of the cylinder or to equal an air path error of the cylinder as a function of a comparison of the first injection quantity correction with the second injection quantity correction.

In this way, two equalization methods known per so can advantageously be combined. The combination according to the invention makes it possible to distinguish between the fuel path error of the cylinder and the air path error of the cylinder when there is a mixture divergence in a cylinder of the internal combustion engine. Distinction is possible if, in the underlying torque and lambda equalization methods, any mixture correction of a cylinder to be corrected is ascertained exclusively with respect to its fuel path, that is to say with respect to a correction of the injection quantity of the cylinder or a correction of the injection time of the cylinder.

In the case of a fuel path error of the cylinder, a correction relating to the fuel path results in the cylinder, after the correction, not only having the same lambda, in other words the same air/fuel ratio, as the rest of the cylinders again, but also the same fuel quantity and the same air quantity.

Therefore, in the case of a fuel path error, a fuel path correction results at the same time as a lambda equalization and a torque equalization because, in the case of correction, both the fuel-air ratio and the absolute quantity of fuel are corrected.

In the case of an air path error of the cylinder, a correction relating to the fuel path of the cylinder cannot bring about a lambda equalization and a torque equalization simultaneously. It can be seen that, for example in the case of an air excess error, i.e. in the case of an error of the air path of the cylinder in which the cylinder contains too much air, a lambda equalization method carries out a fuel path correction to increase the supply of fuel in order to restore the original lambda value of the cylinder. In contrast, in this case, a torque equalization method will result in a fuel path correction that reduces the supply of fuel in order to reduce the torque contribution, which was increased as a result of the air excess, back to the original value.

Therefore, by ascertaining a first injection quantity correction of the cylinder to a torque approximation and/or torque equalization and a second injection quantity correction of the cylinder to a lambda approximation and/or lambda equalization and by comparing the first injection quantity correction with the second injection quantity correction, it is possible to distinguish between an air path and a fuel path error. If the injection quantity correction of the cylinder ascertained through the torque equalization method is essentially the same as the injection quantity correction ascertained through the lambda equalization method, then there is a fuel path error. If the injection quantity correction of the cylinder ascertained through the torque equalization method is essentially different from the injection quantity correction ascertained through the lambda equalization method, then there is an air path error.

A development of the method allows a further differentiation with respect to the cause of an error. In this method, if the first injection quantity correction is essentially larger than the second injection quantity correction, the type of the air-fuel mixture error is set to equal an air deficiency error. On the other hand, if the first injection quantity correction is essentially smaller than the second injection quantity correction, the type of the air-fuel mixture error is indicated to equal an air excess error. In the case of an air deficiency error, a fuel quantity correction in terms of a torque equalization increases the fuel quantity and a fuel quantity correction in terms of a lambda equalization reduces the fuel quantity. In the case of an air excess error, correction quantities are produced in the opposite respective directions.

A particularly advantageous development of the method provides for a specific correction strategy in the case of an air path error.

Even small air path errors of a cylinder noticeably affect the running smoothness of the internal combustion engine and hence driver comfort. Although such small air path errors also cause a minor deterioration in the exhaust gas, this does not exceed any legally prescribed limit value. It is therefore particularly advantageous if, in the case of small air path errors, the injection quantity is corrected in terms of a torque equalization. This correction results, in the case of an air path error, in a further deterioration in the exhaust gas because the lambda value of the cylinder to which this correction relates deteriorates further. However, it is sensible to carry out a correction that improves comfort until the lambda value of the cylinder after correction is essentially equal to a limit lambda value which corresponds to an exhaust gas limit value that is still legally allowed. If the total lambda value, or a lambda value with a specific safety margin from the limit lambda value, is reached, then, for legal reasons, the aim of achieving optimum comfort has to give way to the aim of complying with exhaust gas limit values. This means that, in the case of a further increase in the air path error after the limit lambda value has been reached, an injection quantity correction improving the lambda is carried out. The injection quantity of the cylinder is corrected here so that, if the air path error of the cylinder is gradually increasing, the lambda value of the cylinder does not deteriorate further. When the limit lambda value has been reached, it is sensible to store error information which indicates that there is a comfort-relevant error in the air path of the cylinder concerned. Moreover, if the air path error is so great that the limit lambda value can no longer be kept constant through correction of the injection quantity, then it is sensible to store error information which indicates that there is a law-relevant exhaust gas error in the air path.

Further advantages and features of the invention will become more readily apparent from the following description of exemplary embodiments of the invention with reference to the accompanying drawings, in which the same elements are provided with identical reference numerals.

### BRIEF DESCRIPTION OF THE DRAWINGS

FIG. 1 is a schematic depiction of an internal combustion engine,

FIG. 2 shows the effects of a fuel path error by reference to a diagram showing the dependency of the torque contribution of a cylinder on the lambda value of the cylinder,

FIG. 3 shows the effects of an air path error by reference to a diagram showing the dependency of the torque contribution of a cylinder on the lambda value of the cylinder,

FIG. 4 shows a flow diagram describing the method according to the invention,

FIG. 5 shows the effects of a fuel path error using an alternative embodiment of the method according to the invention by reference to a diagram showing the dependency of the torque contribution of a cylinder on the lambda value of the cylinder,

FIG. 6 shows the effects of an air path error using an alternative embodiment of the method according to the invention by reference to a diagram showing the dependency of the torque contribution of a cylinder on the lambda value of the cylinder.

FIG. 7 shows a flow diagram describing the alternative performance of the method according to the invention, and

FIG. 8 shows diagrams describing the effects of a correction in the case of an air path error.

### DESCRIPTION OF EXEMPLARY EMBODIMENTS

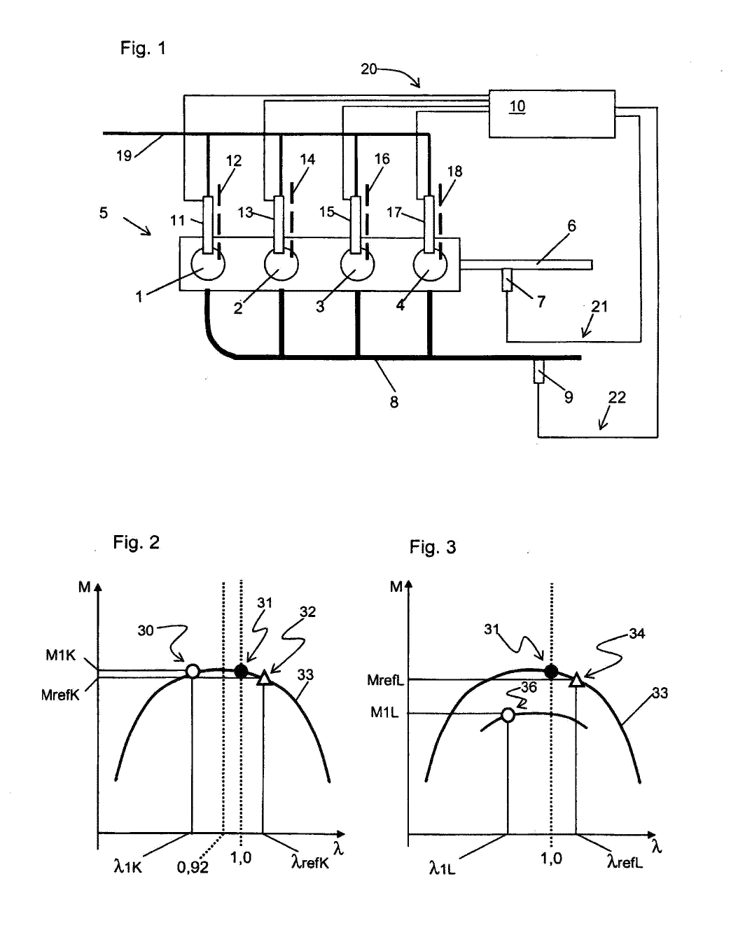

FIG. 1 is a schematic depiction of an internal combustion engine 5, which has four cylinders 1 to 4, wherein an injection valve 11, 13, 15, 17 for injecting fuel into the respective cylinders 1, 2, 3, 4 and an air path 12, 14, 16, 18 for feeding air into the respective cylinders is connected to the cylinders 1, 2, 3, 4 respectively. The injection valves 11, 13, 15, 17 are connected to a fuel delivery system 19. An overall unit consisting of a fuel delivery system 19 and an injection valve 11 or 13 or 15 or 17 of a cylinder 1 or 2 or 3 or 4 is designated as the fuel path of the respective cylinder 1 or 2 or 3 or 4. A quantity of fuel supplied to the cylinders 1, 2, 3, 4 can in each case be influenced by controlling an opening time of the respective injection valve 11, 13, 15, 17. The opening time of an injection valve is also referred to as the injection time. The injection times of the injection valves 11, 13, 15, 17 are controlled by an engine control device 10 which is connected to the injection valves 11, 13, 15, 17 via control lines 20.

The internal combustion engine 5 also has a crankshaft 6 which has a sensor 7 for measuring segment times. The sensor 7 is connected to the engine control unit 10 via a signal line 21. Segment times are measured in order to assess the time taken for a rotation of the crankshaft 6 of the internal combustion engine 5. Segment times are the times that the crankshaft or camshaft takes to cover a predetermined angular range that is assigned to a specific cylinder. Based on the measurement of the segment times, cylinder-specific running smoothness values and cylinder-specific torque contribution values are ascertained in the engine control unit 10.

The internal combustion engine 5 also has an exhaust gas line 8 which is connected to each of the cylinders 1, 2, 3, 4 to accommodate and discharge a combustion exhaust gas. The exhaust gas line 8 has a bandwidth lambda probe 9 which is connected to the engine control unit 10 via a further signal line 22. By means of the broadband lambda probe 9, both a lambda value of the combustion exhaust gas ascertained via the cylinders 1, 2, 3, 4 and a cylinder-specific lambda value for each cylinder 1, 2, 3, 4 can be ascertained.

FIG. 2 shows a diagram describing the dependency of the torque contribution M of a cylinder 1, 2, 3, 4 on the lambda value λ of a cylinder 1, 2, 3, 4. A curve 33 describes the dependency of the torque contribution M of the cylinder 1 selected as an example on the lambda value λ of the cylinder 1 in the case of a constant air supply and a change in the lambda value by a change in the fuel quantity. The curve 33 has the shape of a downwardly open parabola with a maximum lying at a lambda value λ of about 0.92. The torque contribution M of the cylinder 1 hardly changes within the range of lambda values λ between about 0.75 and 1.05 and changes to an increasingly large extent at lambda values λ greater than 1.1 and smaller than 0.7.

FIG. 2 also describes the effect of a fuel path error on the torque contributions M and on the lambda values λ of the cylinder 1. Provided there is no mixture error, in other words neither a fuel path error nor an air path error in any of the cylinders 1, 2, 3, 4, all of the cylinders 1, 2, 3, 4 essentially have the same lambda value λ, under certain operating conditions, for example, the lambda value λ1. In addition, in this error-free case, all of the cylinders 1, 2, 3, 4 make the same torque contribution M under the same operating conditions. Torque contribution M and lambda value λ in the error-free case under the specific operating conditions are represented in the diagram by the black circle 31. The white circle 30 represents the lambda value λ1K and the torque contribution M1K of the cylinder 1 in the case of an error in the fuel path of the cylinder 1, wherein an excess quantity of fuel is injected on each injection. Starting from the coordinates of the black circle 31, the coordinates of the white circle 30, under otherwise the same operating conditions, shift along the curve 33 to the left, in other words in the direction of the lower lambda value λ1K or in the direction of a stronger mixture of the cylinder 1. According to the shape of the curve 33 described above, the torque contribution M changes only insignificantly in the direction of the torque contribution M1K. Based on a lambda regulation which, after measurement of the averaged lambda value at the lambda probe 9, sets an averaged lambda value of 1 again, in order to correct the fuel path error of the cylinder 1, all of the cylinders 1, 2, 3, 4 are slightly weakened by the injection times of all of the injection valves being shortened. The result of this is that the cylinder 1 ends up with a lambda value λ1K and a torque contribution M1K. The cylinders 2, 3, 4 then each have a lambda value λrefK and a torque contribution MrefK, as is represented by the white triangle 32.

FIG. 3 shows a diagram with the same parameters as in FIG. 2, but in the case of an air path error of the cylinder 1. The error-free initial situation is again represented by the black circle 31. The cylinder 1 is now strengthened through an air deficiency error. Unlike with strengthening through an excess of fuel, in the case of strengthening through a deficiency of air there is a clear reduction in the torque contribution M of the cylinder 1. Torque contribution M and lambda value λ of the cylinder 1 move in the diagram in FIG. 3 towards a white circle 36, i.e. in the direction of a torque contribution M1L and of a lambda value λ1L. Via the lambda regulation described above, in order to reach an average lambda value λ of 1, the cylinders 1, 2, 3, 4 are weakened via a shortening of their injection time. Torque contributions M and lambda values λ of the cylinders 2, 3, 4 move along the curve 33 towards the white triangle 34 because only their fuel quantity is being changed.

Both error cases, that is to say the fuel path error shown in FIG. 2 and the air path error shown in FIG. 3, result in
an average lambda value λ corresponding to the desired lambda value averaged over all of the cylinders 1, 2, 3, 4,
cylinder-specific lambda values differing in each case from the desired lambda value in all of the cylinders 1, 2, 3, 4, resulting in a deterioration in the exhaust gas values of the internal combustion engine 5,
a different torque contribution M1 of the cylinder 1 compared to the torque contributions Mref of the cylinders 2, 3, 4, resulting in a deterioration in the running smoothness of the internal combustion engine 5.

FIGS. 2 and 3 show the two cases (fuel path error and air path error) in respect of a defective strengthening shift of the fuel-air mixture in a single cylinder and the consequences of this.

In an unshown case of a fuel path error with a fuel deficiency in the cylinder 1, the points for the torque contributions M and the lambda values λ of the cylinders 1, 2, 3, 4 shift, for the reasons specified above, along the curve 33, but, compared to FIG. 2, each in the opposite direction.

In a case (not shown) of an air path error with an air deficiency in the cylinder 1, the points for the torque contributions M and the lambda values λ of the cylinders 1, 2, 3, 4 in principle result from the fact that the points 36 and 34 in FIG. 3 are point reflected at point 31.

The different effects of a fuel path error and of an air path error shown in FIGS. 2 and 3 on the torque contributions M and the lambda values λ of the cylinders 1 to 4 can be assessed according to the invention in order to distinguish between an air path error and a fuel path error.

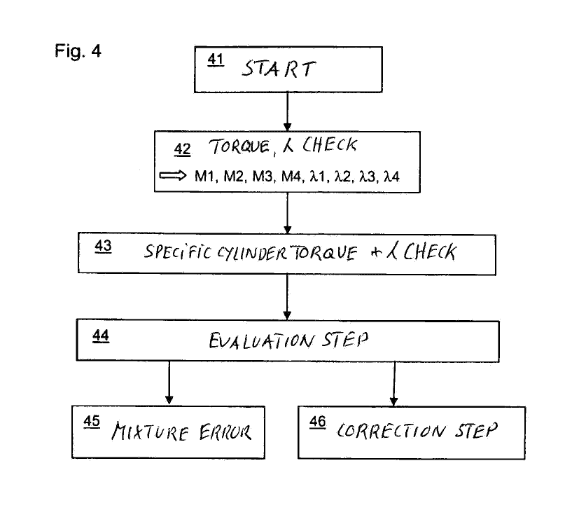

FIG. 4 shows a flow diagram representing the method according to the invention. In this method, in a starting step 41 it is checked whether operating conditions of the internal combustion engine 5 exist which allow a representative measurement of the torque contributions M1, M2, M3, M4 and of the lambda values λ1, λ2, λ3, λ4 of the cylinders 1 to 4. Amongst other things, it is checked in the starting step whether the internal combustion engine 5 is being operated at a suitable desired lambda value.

If the corresponding operating conditions exist, an ascertainment step 42 is carried out to ascertain the torque contributions M1, M2, M3, M4 and the lambda values λ1, λ2, λ3, λ4 of the cylinders 1 to 4.

A determination step 43 is then carried out. In the determination step 43, in a predefined manner, each cylinder-specific value of the torque contributions M1, M2, M3, M4 and lambda values λ1, λ2, λ3, λ4 is respectively compared with a suitable reference value Mref or λref. It is particularly easy and therefore advantageous to use, as the reference value, the average value of those cylinders whose respective values are particularly close to one another. In the case of the internal combustion engine 5 having a defective cylinder 1, the lambda values λ2, λ3, λ4 of the other cylinders will be close to one another and the torque contributions M2, M3, M4 of the other cylinders will be close to one another. The relative shift in the values M1, M2, M3, M4 compared to Mref and in the values λ1, λ2, λ3, λ4 compared to λref can be ascertained in respect of the defect cases listed below experimentally for the specific internal combustion engine 5 in each case. The following picture is essentially produced:
Defect case 1 (the case shown in FIG. 3): there is a lower lambda value λ1 (stronger) and a lower torque contribution M1 of the defective cylinder 1 in comparison with the lambda values λ2, λ3, λ4 and the torque contributions M2, M3, M4 of the other cylinders 2 to 4; the cause “air deficiency error of the cylinder 1” is ascribed to defect case 1 for the reasons described above;
Defect case 2: there is a higher lambda value λ1 (weaker) and a higher torque contribution M1 of the defective cylinder 1 in comparison with the lambda values λ2, λ3, λ4 and the torque contributions M2, M3, M4 of the other cylinders 2 to 4; the cause “air excess error of the cylinder 1” is ascribed to defect case 2 for the reasons described above;
Defect case 3: there is a higher lambda value λ1 (weaker) and a lower or approximately the same torque contribution M1 of the defective cylinder 1 in comparison with the lambda values λ2, λ3, λ4 and the torque contributions M2, M3, M4 of the other cylinders 2 to 4; the cause “fuel deficiency error of the cylinder 1” is ascribed to defect case 3 for the reasons described above;
Defect case 4 (the case shown in FIG. 2): there is a lower lambda value λ1 (stronger) and approximately the same or a slightly higher torque contribution M1 of the defective cylinder 1 in comparison with the lambda values λ2, λ3, λ4 and the torque contributions M2, M3, M4 of the other cylinders 2 to 4; the cause “fuel excess error of the cylinder 1” is ascribed to defect case 4 for the reasons described above.

Instead of the average values specified above, lambda values and torque contribution values which correspond to an error-free state of the internal combustion engine 5 can also be used as reference values. Such values can be approximately ascertained in the new state of the internal combustion engine 5 under the same operating conditions as those of the ascertainment step 42 and stored in the engine control unit 10.

After the determination step 43, a measure step 44 is carried out. In the measure step 44, the findings made in the determination step 43 are, on the one hand, processed to identify a type of air-fuel mixture error 45, the latter in each case indicating the cause of the above defect cases, if so allowed by the accuracy of determination of the specific system concerned. On the other hand, the measure step 44 initiates a correction step 46 in which the injection time and/or an air mass and/or an ignition angle for the cylinders 1 to 4 is corrected so that the lambda values and/or the torque contribution values of the cylinders 1 to 4 are essentially equalized.

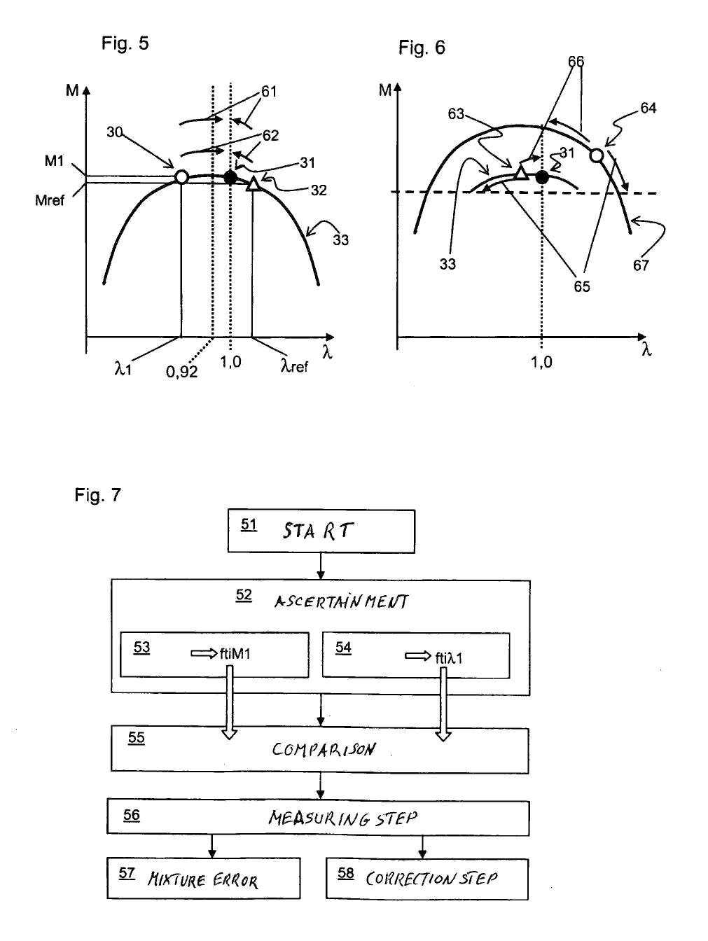

FIGS. 5, 6 and 7 describe an alternative embodiment of the method according to the invention. In the alternative embodiment, use is made of the fact that, in the case of an air path error of a cylinder 1, through correction of the quantity of fuel alone, either the torque contributions M1, M2, M3, M4 of all of the cylinders 1 to 4 or the lambda contributions λ1, λ2, λ3, λ4 of all of the cylinders 1 to 4 can be equalized. In the case of an air path error, it is impossible to equalize, through correction of the quantity of fuel alone, both the torque contributions M1, M2, M3, M4 and the lambda values λ1, λ2, λ3, λ4.

FIG. 5 shows the same diagram as FIG. 2, in other words a fuel path error of the cylinder 1. In this figure, the arrows 61 show the movement of the diagram points over the course of an injection time change for lambda equalization and the arrows 62 show the movement of the diagram points over the course of an injection time change for torque equalization. Lambda equalization and torque equalization produce the same result provided the injection time of the cylinders 1 to 4 is used as the correction parameter. This means that, both in the case of lambda equalization (arrows 61) and in the case of torque equalization (arrows 62), there is a reduction in the injection time to weaken the mixture in the cylinder 1 (white circle 30) and an increase in the injection time to strengthen the mixture in cylinders 2 to 4 (white triangle 32). After correction, all of the cylinders 1 to 4 once again essentially have the torque contribution values and lambda values represented by the black circle 31.

FIG. 6 shows a similar diagram, but in this case showing an air path error in the cylinder 1. The white circle 64 indicates the torque contribution M and the lambda value λ of the defective cylinder 1. Compared to the defect-free state characterized by the black circle 31, the cylinder 1, owing to an increased air mass in the cylinder 1, has a higher lambda value λ and an increased torque contribution M. The other cylinders 2 to 4, characterized by the white triangle 63, have a slightly strong mixture owing to the effect of the lambda regulation described above. The curves 33 and 67 show the dependency of the torque contribution M on the lambda value λ when the air mass is constant. The curve 67 of the cylinder 1 lies above the curve 33 of the cylinders 2 to 4 because the cylinder 1 has a higher torque contribution M owing to its increased air mass. A change of the torque contribution M and of the lambda value λ of the cylinder 1, i.e. a shift of the white circle 64, through correction of the injection time of the cylinder 1, can only take place along the curve 67. Similarly, a change of the torque contribution M and of the lambda value λ of the cylinders 2 to 4, i.e. a shift of the white triangle 63, through correction of the injection time of the cylinders 2 to 4, can only take place along the curve 33. As a result, by changing the injection times of the cylinders 1 and 2 to 4, either the torque or the lambda can be equalized, but not both.

A lambda equalization, indicated by the arrows 66, is achieved by strengthening of the cylinder 1, i.e. by increasing the injection time of the cylinder 1 and at the same time weakening cylinders 2 to 4, i.e. by lowering the injection time of cylinders 2 to 4.

A torque equalization, indicated by the arrows 65, is achieved by weakening of the cylinder 1, i.e. by reducing the injection time of the cylinder 1 and at the same time strengthening cylinders 2 to 4, i.e. by increasing the injection time of cylinders 2 to 4.

The circumstances described in FIGS. 5 and 6 can be processed to form the alternative method for determining the type of air-fuel mixture error if there is an air-fuel mixture error according to the invention. The alternative method is described in FIG. 7. In the alternative method according to the invention, an ascertainment step 52 is initiated after it has been checked, in a starting step 51, amongst other things, whether suitable operating conditions of the internal combustion engine 5 exist for performance of the ascertainment step 52. The ascertainment step 52 consists of a first subsidiary step 53 and a second subsidiary step 54. The first subsidiary step 53 includes determination of a first injection time correction ftiM1 for the cylinder 1, which determination is carried out in a manner known per se according to a torque equalization method. The second subsidiary step 54 includes determination of a second injection time correction ftiλ1 for the cylinder 1, which determination is carried out in a manner known per se according to a lambda equalization method.

In a comparison step 55, the first injection time correction ftiM1 and the second injection time correction ftiλ1 are compared and further processed in the manner described below:
if the first injection time correction ftiM1 and the second injection time correction ftiλ1 are the same, then the existence of a fuel error is established,
if the first injection time correction ftiM1 is larger than the second injection time correction ftiλ1, then the existence of an air deficiency error is established,
if the first injection time correction ftiM1 is smaller than the second injection time correction ftiλ1, then the existence of an air excess error is established.

In the measure step 56, the findings made in the comparison step 55 are, on the one hand, processed to identify a type of air-fuel mixture error 57, the latter in each case indicating the cause of the above defect cases, if so allowed by the accuracy of determination of the specific system concerned. On the other hand, the measure step 56 initiates a correction step 58 in which the injection time and/or the air mass and/or the ignition angle of the cylinders 1 to 4 is corrected so that the lambda values and/or the torque contribution values of the cylinders 1 to 4 are essentially equalized.

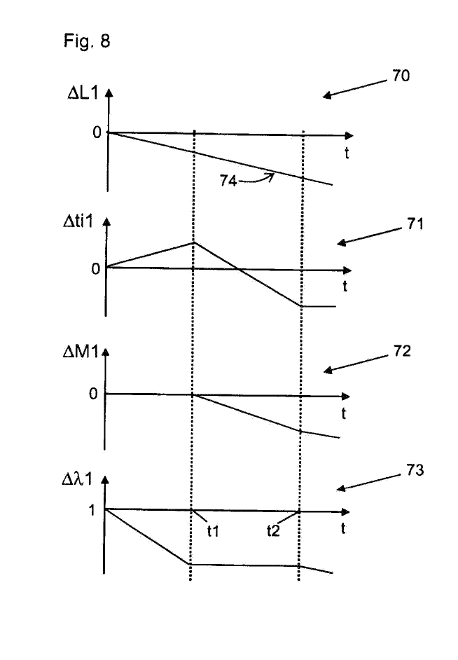

FIG. 8 describes a particularly advantageous embodiment of the measure step 44 of FIG. 4 and of the measure step 56 of FIG. 7 in the case of an air path error.

A first diagram 70 shows a divergence ΔL1 of an air mass of the first cylinder over the time t. A curve 74 describes an air deficiency error of the cylinder 1 which increases slowly over time. The air deficiency error of the cylinder 1 is determined in a manner according to the invention. Owing to the fact that, in the case of a still small air deficiency error, in other words before the time t1, an exhaust gas value is still within a legally permitted range, an injection time correction in terms of torque equalization takes place at the beginning, i.e. before time t1. A second diagram 71 shows the course of an injection time change Δti1 of the first cylinder over time t. The injection time change Δti1 of the first cylinder is initially positive in order to achieve a constant torque contribution M of the first cylinder. A third diagram 72 shows the course of a torque contribution change ΔM1 of the first cylinder over time. As a result of the injection time correction, the torque contribution M1 of the first cylinder does not change even though there is an air deficiency error. On the other hand, the injection time correction to maintain the torque contribution M1 of the first cylinder has a detrimental effect on the lambda value λ1 of the first cylinder. A fourth diagram 73 shows the course of a lambda value change Δλ1 of the first cylinder over time. Before time t1, there is a rapidly increasing strengthening of the first cylinder because the air deficiency error and the strengthening to maintain the torque contribution have an increasingly strengthening effect. At time t1, the strengthening of the first cylinder has progressed so far that an exhaust gas value has reached a legally prescribed limit value. From time t1, the correction strategy is changed such that, from time t1, with the air deficiency error of the cylinder 1 continuing to increase, the injection time of the cylinder 1 is corrected so that the lambda value λ1 of the first cylinder does not deteriorate further. Therefore, before time t1, there is a correction of the injection time based on comfort and, after time t1, there is a correction of the injection time based on exhaust gas. After time t1, with the increasing air deficiency error, the injection time is reduced, resulting in a torque contribution of the cylinder 1 that declines over time and an essentially constant lambda value λ1 of the cylinder 1. The course of parameters described in diagrams 70 to 73 relates to the same operating conditions of the internal combustion engine 5 and describes an air deficiency error gradually increasing over time t.

At time t2, a limit value for the change in injection time set by the system is reached. As a result, from time t2, no further correction is possible, so that, after time t2, at least an exhaust gas value exceeds its legal limit value.

According to the invention, at time t1, a first piece of error information is stored in the error memory of the engine control unit 10, wherein the first piece of error information indicates an air deficiency error that is relevant as far as comfort is concerned. At time t2, a second piece of error information is stored in the engine control unit 10, wherein the second piece of error information indicates an air deficiency error that is relevant as far as exhaust gas quality is concerned.

If there is a gradually increasing air excess error, according to the invention, the same correction principle is applied: until a limit divergence of the lambda value of the cylinder concerned is reached, an injection time change in terms of a torque equalization of the internal combustion engine 5 is carried out and, when the limit divergence of the lambda value of the cylinder concerned is reached, an injection time change in terms of a lambda equalization is carried out. The error entries are made according to times t1 and t2 for an air excess error that is relevant as far as comfort is concerned or an air excess error that is relevant as far as exhaust gas quality is concerned.

What is claimed is:

1. A method for determining a type of air-fuel mixture error (45, 57) of a cylinder (1) of an internal combustion engine (5) of a motor vehicle, comparing the steps of:
determining a torque parameter (M1K, M1L) of the cylinder (1),
determining a lambda parameter (λ1K, λ1L) of the cylinder (1),
determining a torque reference parameter (MrefK, MrefL) and a lambda reference parameter (λrefK, λrefL), and
as a function of a comparison of the torque parameter (M1K, M1L) with the torque reference parameter (MrefK, MrefL) and as a function of a comparison of the lambda parameter (λ1K, λ1L) with the lambda reference parameter (λrefK, λrefL), setting the type of air-fuel mixture error (45) to equal one of a fuel path error of the cylinder (1) and an air path error of the cylinder (1).

2. The method according to claim 1, wherein the torque parameter (M1K, M1L) of the cylinder (1) is dependent on a running smoothness value of the cylinder (1).

3. The method according to claim 1, wherein the torque parameter (M1K, M1L) of the cylinder (1) is dependent on a segment time relating to the cylinder (1) at a crankshaft (6) of the internal combustion engine (5).

4. The method according to claim 1, wherein the torque reference parameter (MrefK, MrefL) of the cylinder (1) is dependent on the torque parameters of the other cylinders (2, 3, 4) of the internal combustion engine (5) and the lambda reference parameter (λrefK, λrefL) is dependent on the lambda parameters of the other cylinders (2, 3, 4) of the internal combustion engine (5).

5. The method according to claim 1, wherein
in the case of a lambda parameter (λ1L) of the cylinder (1) which is shifted to be stronger in comparison with the lambda reference parameter (λrefL) of the cylinder (1), and a torque parameter (M1L) of the cylinder (1) which is shifted in the direction of a lower torque contribution in comparison with the torque reference parameter (MrefL) of the cylinder (1), an air error that is in particular an air deficiency error, is indicated,
in the case of a lambda parameter (λ1) of the cylinder (1) which is shifted to be weaker in comparison with the lambda reference parameter (λref) of the cylinder (1), and a torque parameter (M1) of the cylinder (1) which is shifted in the direction of a higher torque contribution in comparison with the torque reference parameter (Mref) of the cylinder (1), an air error that is in particular an air excess error, is indicated,
in the case of a lambda parameter (λ1) of the cylinder (1) which is shifted to be weaker in comparison with the lambda reference parameter (λref) of the cylinder (1), and a torque parameter (M1) of the cylinder (1) which is shifted in the direction of a lower torque contribution in comparison with the torque reference parameter (Mref) of the cylinder (1), a fuel error that is in particular a fuel deficiency error, is indicated, and
in the case of a lambda parameter (λ1K) of the cylinder (1) which is shifted to be stronger in comparison with the lambda reference parameter (λref) of the cylinder (1), and a torque parameter (M1K) of the cylinder which is essentially the same in comparison with the torque reference parameter (MrefK) of the cylinder (1), a fuel error that is in particular a fuel excess error, is indicated.

6. The method according to claim 1, wherein
as a function of a comparison of the torque parameter with the torque reference parameter according to a torque equalization method (53), a first injection quantity correction (ftiM1) is ascertained and
as a function of a comparison of the lambda parameter with the lambda reference parameter according to a lambda equalization method (54), a second injection quantity correction (ftiλ1) is ascertained and
as a function of a comparison (55) of the first injection quantity correction (ftiM1) with the second injection quantity correction (ftiλ1), the type of air-fuel mixture error (57) indicated to equal either a fuel path error of the cylinder (1) or an air path error of the cylinder (1), and
wherein
if the first injection quantity correction (ftiM1) is essentially the same as the second injection quantity correction (ftiλ1), the type of air-fuel mixture error (57) indicated to be a fuel path error, and
if the first injection quantity correction (ftiM1) is not the same as the second injection quantity correction (ftiλ1), the type of air-fuel mixture error (57) is indicated to equal an air path error.

7. The method according to claim 6, wherein
if the first injection quantity correction (ftiM1) is larger than the second injection quantity correction (ftiλ1), the type of air-fuel mixture error (57) is indicated to be an air deficiency error, and
if the first injection quantity correction (ftiM1) is smaller than the second injection quantity correction (ftiλ1), the type of air-fuel mixture error (57) is indicated to be an air excess error.

8. The method according to claim 7, wherein
if there is an air path error of the cylinder (1), the injection quantity of the cylinder (1) is corrected in two ways, wherein
in the case of an air path error having a small divergence of the lambda parameter of the cylinder from the lambda reference parameter to a limit divergence of the lambda parameter, the injection quantity of the cylinder is changed according to a torque equalization method so as to increase the divergence of the lambda parameter,
in the case of an air path error having the limit divergence of the lambda parameter of the cylinder from the lambda reference parameter, the injection quantity of the cylinder is changed according to a lambda equalization method so as to keep the lambda parameter constant.

9. The method according to claim 8, wherein
in the case of an air path error and a limit divergence of the lambda parameter, a piece of error information is stored which indicates an error in the air path of the cylinder concerned that is relevant as far as comfort is concerned, and
in the case of an air path error and an exceeding of the limit divergence of the lambda parameter, a piece of error information is stored which indicates an exhaust gas error in the air path that is relevant as far as the legal requirements are concerned.
